(19) United States
(12) Patent Application Publication
(10) Pub. No.: US 2026/0058509 A1
(43) Pub. Date: Feb. 26, 2026

(54) OUTER ROTOR TYPE MOTOR

(71) Applicant: SHINANO KENSHI KABUSHIKI KAISHA, Nagano (JP)

(72) Inventors: Shun TAKAYAMA, Nagano (JP); Akihiko YAMAMOTO, Nagano (JP)

(21) Appl. No.: 19/265,107

(22) Filed: Jul. 10, 2025

(30) Foreign Application Priority Data
Aug. 21, 2024 (JP) 2024-139572

(51) Int. Cl. H02K 1/2706; H02K 1/14; H02K 3/18

(52) U.S. Cl. CPC H02K 1/2706; H02K 1/14; H02K 3/18

(57) ABSTRACT

An insulator 7 covering a stator core 5a includes at a radial-direction inner side a tubular part 7a extending axially. The tubular part 7a includes, at circumferentially multiple positions of the tubular part 7a, snap fits inserted into a through-hole 6c of a motor substrate 6 to be locked with respective lock concave parts 6d formed at a hole wall surface of the through-hole 6c, to axially and radially position and hold the motor substrate 6 with respect to the stator 5. The stator 5 is concentrically assembled on an outer peripheral side of a housing accommodation part 4d accommodating a bearing housing 8a while the snap fits 7b position and hold the motor substrate 6.

### CROSS-REFERENCE TO RELATED APPLICATION

This application is based upon and claims the benefit of priority of the prior Japanese Patent Application No. 2024-139572, filed on Aug. 21, 2024, and the entire contents of which are incorporated herein by reference.

### TECHNICAL FIELD

The present invention relates to an outer rotor type motor used as a drive source for, for example, in-vehicle equipment or an HVAC (Heating, Ventilation, and Air Conditioning) system.

### BACKGROUND ART

For example, in a brushless outer rotor type motor, a motor substrate provided with a hall element (magnetic pole detection element) that detects a position of a rotor magnetic pole created by a permanent magnet is positioned and fixed in such a manner as to be overlapped with a housing including a bearing accommodation part. A spacer that accommodates the hall element is positioned and fixed in such a manner as to be overlapped with the motor substrate. A lead terminal of the hall element is soldered to the motor substrate. Moreover, a stator core with stator pole teeth wound by a motor coil is assembled to the spacer. Finally, the housing, the motor substrate, and the stator core are integrally fixed to one another by using screws, and thereby mutual positioning and assembling of the hall element, the stator core, and the motor substrate are performed (PTL 1: JP-A-H10-191612).

Furthermore, a motor substrate assembled around a tubular bearing housing in such a manner that the bearing housing is fixed to a base portion is locked by a hook part provided to project from an insulator being inserted into a lock hole. The hook part is provided to the insulator to project in an axial direction at a position corresponding to a tip-end portion of a respective one of stator pole teeth, and is inserted into the lock hole of the motor substrate to be locked. A lead terminal of a stator winding wire is soldered to the motor substrate (PTL 2: JP-A-H9-252557).

### SUMMARY OF INVENTION

### Technical Problem

In PTL 1 described above, the hall element is accommodated and assembled between the motor substrate and the stator core through the spacer. Therefore, the number of components is large and the size increases in the axial direction. Moreover, processing man-hours and assembling man-hours for positioning of the housing, the motor substrate, the spacer, and the stator core increase, which results in an increase in manufacturing costs.

With the configuration of PTL 2 in which the hook part projectingly provided to the insulator holds the motor substrate, an assembling posture of the motor substrate with respect to a rotor shaft, that is, a shaft perpendicularity, easily decreases. Therefore, a position of a hall IC relative to a rotor magnetic pole may vary, which results in a decrease in motor characteristics. Particularly, in addition to rotational vibration, external vibration in accordance with usage environment and the like are applied to a motor used for in-vehicle equipment. Therefore, the stator and the motor substrate may positionally be shifted in an axial direction and a rotational direction. Accordingly, a crack may occur to a solder joint between the lead terminal of the motor coil and a substrate terminal of the motor substrate. Moreover, positional displacement of the hall IC by 1° in a mechanical angle causes positional displacement of a detection signal of the hall IC by 3° in an electric angle, which lowers motor controllability.

### Solution to Problem

The present invention has been accomplished under the above problems, and an object thereof is to provide an outer rotor type motor capable of surely achieving positioning of a stator and a motor substrate in an axial direction and a rotational direction with a simple configuration, and having favorable assemblability.

The invention includes the following configurations to achieve the object.

An outer rotor type motor includes a stator including stator magnetic poles created by winding of a winding wire around a plurality of pole teeth projectingly provided to a stator core with an insulator interposed between the winding wire and the plurality of pole teeth; and
a rotor including rotor magnetic poles arranged to face the stator magnetic poles on a radial-direction outer side of the stator, the rotor magnetic poles being created by permanent magnets, wherein
the stator is provided with a motor substrate including a magnetic pole detection element configured to detect a position of the rotor magnetic poles,
the insulator covering the stator core includes at a radial-direction inner side of the insulator a tubular part extending in an axial direction, the tubular part including, at a plurality of positions in a circumferential direction of the tubular part, snap fits inserted into a through-hole of the motor substrate to be locked with respective ones of lock concave parts to position and hold the motor substrate with respect to the stator in the axial direction and a radial direction, the lock concave parts being formed at a hole wall surface of the through-hole, and
the stator is concentrically assembled on an outer peripheral side of a housing accommodation part accommodating a bearing housing while the snap fits position and hold the motor substrate.

In this manner, the plurality of snap fits projectingly provided to the tubular part of the insulator in the circumferential direction is inserted into the through-hole of the motor substrate and locked with the respective ones of the lock concave parts formed at the hole wall surface of the through-hole, and thus holds the motor substrate. Accordingly, the plurality of snap fits can position the motor substrate with respect to the stator in the axial direction as well as in the rotational direction.

Each of the snap fits preferably includes a holding part projectingly provided to the tubular part of the insulator. The holding part is preferably formed in a tapered shape by a radially inner tapered part and a radially outer tapered part. The holding part is preferably locked with the motor substrate at a stepped part projectingly provided at the radial-direction outer side in such a manner as to continue to the radially outer tapered part.

Accordingly, during assembling of the stator and the motor substrate, while the radially outer tapered part is guided by a peripheral edge portion of the through-hole of the motor substrate to be deformed in the radial-direction inner side, the holding part of the snap fit can be locked with a substrate opposite surface at the stepped part. Therefore, the motor substrate can be positioned and held with respect to the stator. Moreover, during concentric assembling, on the outer peripheral side of the housing accommodation part accommodating the bearing housing, of the stator to which the motor substrate is assembled (stator Assy), the radially inner tapered part of the snap fit is guided by an opening end portion of the housing accommodation part to be deformed to the radial-direction outer side, and interference of the radially inner tapered part with the housing accommodation part is avoided. Therefore, assembling of the stator to the housing can easily be performed.

Each of the snap fits is preferably projectingly provided between the stator pole teeth in the circumferential direction of the tubular part. In this manner, when the snap fit is provided between the stator pole teeth, the snap fit does not affect winding work by a winding machine during winding of a motor coil around the stator pole teeth.

The tubular part may include a butting member between the snap fits. The butting member may define a position of the motor substrate in the axial direction in such a manner as to abut on a surface of the motor substrate in the axial direction and catch the motor substrate together with the snap fits.

Accordingly, during assembling of the stator and the motor substrate, as the tubular part of the insulator is inserted into the through-hole of the motor substrate, the butting member contacts an upper surface of the substrate, and the holding parts are locked with a lower surface of the substrate upon insertion of the snap fits into the through-hole. Therefore, a position of the motor substrate with respect to the stator in the axial direction is defined.

The tubular part may include a projection part between the snap fits. The projection part may be fitted, for positioning in a rotational direction, into a notch part provided at a respective one of radially opposite positions of the through-hole of the motor substrate.

Accordingly, during assembling of the stator to the motor substrate, as the tubular part of the insulator is inserted into the through-hole of the motor substrate, the projection part provided between the snap fits is fitted into the notch part provided at the respective one of the radially opposite positions of the through-hole. Therefore, the motor substrate is positioned in the rotational direction, and rotation of the motor substrate can surely be detained. Accordingly, variation in assembling can be reduced, and a decrease in motor characteristics due to positional displacement of the motor substrate with respect to the stator as a result of motor vibration and external vibration in accordance with usage environment can be prevented.

The insulator may be insert-molded with the stator core and include the tubular part, and the tubular part may include a projection tip-end portion in a plate-spring shape at which a holding part is formed. Accordingly, the number of components can be reduced and downsizing is achievable as compared with a case in which the insulator is a separate component, and assembling work of the stator and assembling work of the stator and the motor substrate can easily be performed.

### Advantageous Effects of Invention

An outer rotor type motor capable of surely achieving positioning of a stator and a motor substrate in an axial direction and a rotational direction with a simple configuration, and having favorable assemblability can be provided.

### BRIEF DESCRIPTION OF DRAWINGS

FIG. 1 is a plan view of a centrifugal blower.

FIG. 2 is a sectional view of the centrifugal blower in FIG. 1 taken along arrow B-B.

FIG. 3A is a perspective view of a stator, and FIG. 3B is a plan view of the stator.

FIG. 4A is a perspective view in which a motor substrate is assemble to a stator when seen from the stator side, FIGS. 4B and 4C are perspective views in which the motor substrate is assemble to the stator when seen from the substrate side, and FIG. 4D is a plan view in which the motor substrate is assemble to the stator when seen from the substrate side.

FIG. 5A is a front view showing a step to assemble, to a bottom housing, a stator assembly including a stator and a motor substrate assembled together, and FIG. 5B is a sectional view taken along arrow A-A in FIG. 5A.

FIG. 6A is a front view in which a stator assembly including a stator and a motor substrate assembled together is assembled to a bottom housing, and FIG. 6B is a sectional view taken along arrow A-A in FIG. 6A.

### DESCRIPTION OF EMBODIMENTS

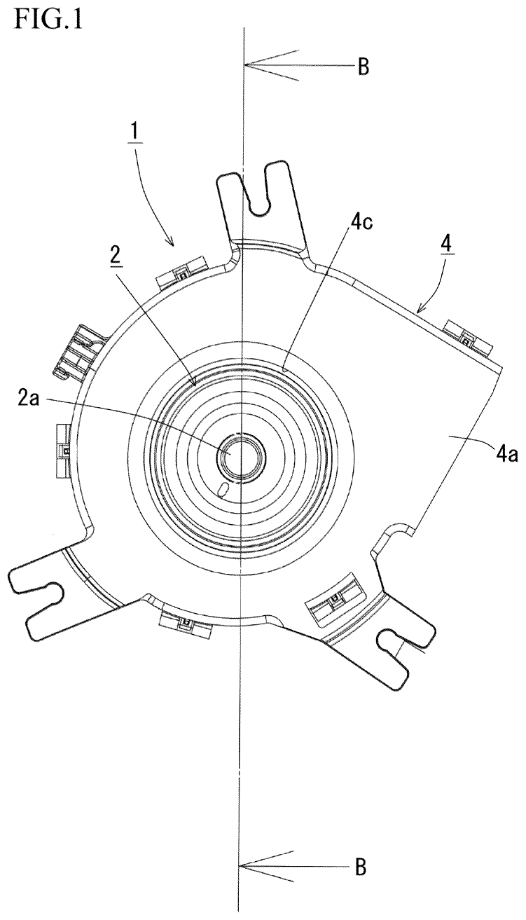

Hereinafter, an embodiment of an outer rotor type motor according to the present invention is described with reference to the accompanying drawings. First, an outline structure of the outer rotor type motor is described with reference to FIGS. 1 to 6B. A DC brushless motor used for in-vehicle equipment is described as an example of an outer rotor type motor M. Below, a centrifugal blower whose drive source is an outer rotor type motor is described as an example.

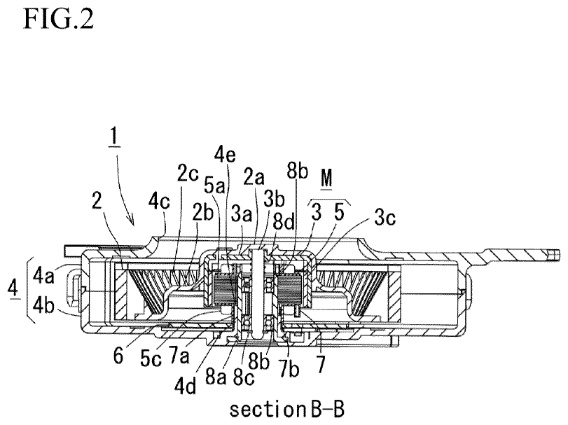

In FIG. 1, in a centrifugal blower 1, a centrifugal fan 2 and a rotor 3 are integrally assembled, and an outer rotor type motor M that rotary drives the centrifugal fan 2 and the rotor 3 is housed inside a blower housing 4. In FIG. 2, the blower housing 4 is formed by combination of a top housing 4a and a bottom housing 4b. The top housing 4a is assembled to cover the centrifugal fan 2. The bottom housing 4b axially supports the outer rotor type motor M (the rotor 3 and a stator 5) in a rotatable manner. An intake opening part 4c is provided to a center part of the top housing 4a. Air is taken in from the intake opening part 4c, and air which is pressurized from the radial-direction outer side is exhausted in a circumferential direction.

The centrifugal fan 2 includes, at a radial-direction center part, a hub 2a assembled integrally with a rotor yoke 3a. The centrifugal fan 2 is insert-molded with the rotor yoke 3a, and a top-surface part of the rotor yoke 3a and the hub 2a are integrated with one another. A main plate 2b continuing to the hub 2a is provided to extend in a stepped manner to the radial-direction outer side. A plurality of curved impellers 2c is formed upright on the main plate 2b from the radial-direction inner side to the radial-direction outer side.

The outer rotor type motor M includes the rotor 3 and the stator 5. The rotor 3 includes a rotor shaft 3b assembled to a hub of the rotor yoke 3a formed in a cup shape. An annular rotor magnet 3c is provided to an inner peripheral surface of the rotor yoke 3a. The rotor magnet 3c includes rotor magnetic poles created by permanent magnets magnetized to have an N-pole and an S-pole alternately in a circumferential direction. The rotor 3 is assembled on the radial-direction outer side of the stator 5 in such a manner that the rotor magnetic poles of the rotor magnet 3c are arranged to face stator magnetic poles.

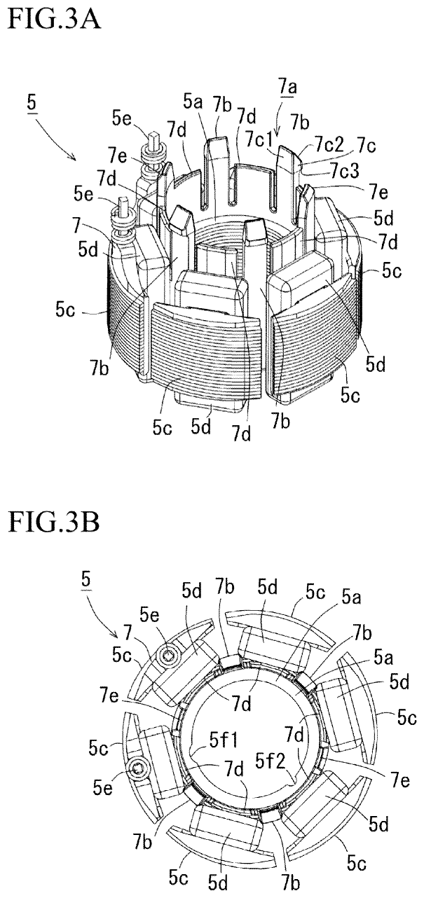

In FIGS. 3A and 3B, the stator 5 includes, at an annular stator core 5a, a plurality of pole teeth 5c provided to project to the radial-direction outer side. A motor coil 5d is wound around the plurality of pole teeth 5c with an insulator 7 interposed therebetween, thus creating the stator magnetic poles. Although in this embodiment a single-phase coil is wound, a three-phase coil or the like may be wound. Moreover, coil pins 5e connected to the motor coil 5d are provided to the insulator 7 at two positions. A coil lead extended from the motor coil 5d is connected to each coil pin 5e. As illustrated in FIG. 3B, at an inner peripheral surface of the annular stator core 5a, a groove 5f1 for positioning with respect to a winding machine during assembling is formed. Moreover, the outer shape of each pole teeth 5c is eccentric, and therefore a groove 5f2 is formed to determine an assembling direction of the stator core 5a with respect to a housing accommodation part 4d.

In FIG. 2, in the bottom housing 4b of the blower housing 4, a tubular metal bearing housing 8a is insert-molded to be assembled integrally to the housing accommodation part 4d. An upper-end portion 4e of the housing accommodation part 4d defines an assembling position of the stator core 5a as will be described later. Inside a tubular hole of the bearing housing 8a, a pair of bearings 8b are inserted at respective ones of longitudinally both sides of the bearing housing 8a. The rotor shaft 3b is inserted into the bearing housing 8a so as to rotatably be supported by the pair of bearings 8b. A retaining washer 8c is fitted to the rotor shaft 3b at a shaft-end side, and movement of the bearing 8b in the axial direction is regulated by the retaining washer 8c on the axial-direction lower end side. Moreover, between the hub of the rotor yoke 3a and the bearing 8b on the axial-direction upper end side, in order to improve rotational stability of the rotor 3, a pre-loading spring 8d is fitted around the rotor shaft 3b in a state in which the pre-loading spring 8d is compressed further than an equilibrium length.

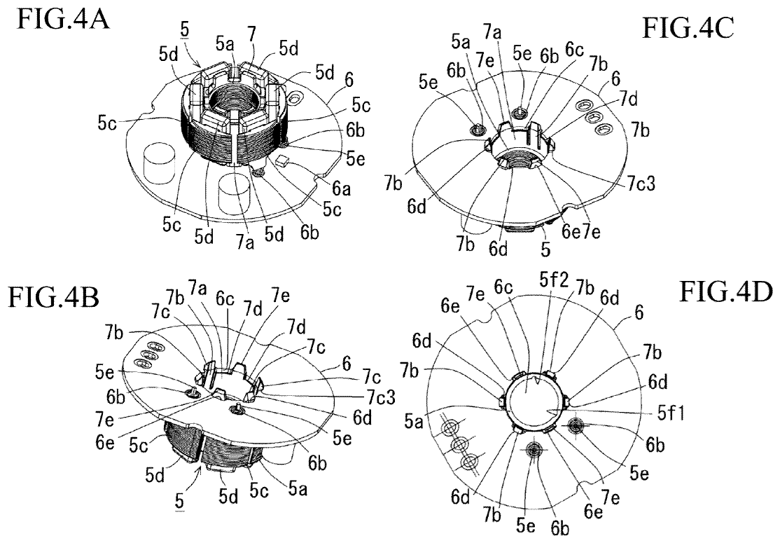

As illustrated in FIG. 4A, the motor substrate 6 includes a magnetic pole detection element 6a, such as a hall IC, to detect a magnetic-pole position of the rotor 3. The motor substrate 6 is fixed to the blower housing 4 (the bottom housing 4b) as will be described later. Moreover, the coil pin 5e connected to the motor coil 5d wound around the pole teeth 5c of the stator core 5a is inserted into a substrate terminal hole 6b and soldered (see FIGS. 4B and 4C). The magnetic-pole position of the rotor 3 is detected by the magnetic pole detection element 6a, and current direction flowing through the motor coil 5d is switched, and thereby the rotor 3 is biased and rotated.

As illustrated in FIGS. 3A and 3B, the stator core 5a is assembled integrally with the insulator 7 by insert-molding. The insulator 7 is formed by insert-molding of the stator core 5a by using, for example, a PBT (polybutylene terephthalate) resin. Note that only the insulator 7 may be molded without insert-molding, and the insulator 7 may be assembled around the pole teeth 5c of the stator core 5a.

The insulator 7 includes, on the radial-direction inner side of the stator core 5a, tubular parts 7a projectingly provided at respective ones of both sides in the axial direction. The motor substrate 6 is assembled to one of the tubular parts 7a as will be described later (see FIGS. 4A to 4D), and the stator 5 and the motor substrate 6 (stator Assy) are assembled to the bottom housing 4b in such a manner that the tubular part 7a is concentrically fitted to an outer peripheral side of the housing accommodation part 4d accommodating the tubular metal bearing housing 8a (see FIG. 2).

The tubular part 7a includes, at an axial-direction end portion thereof, snap fits 7b projectingly provided at a plurality of positions (for example, four positions). The snap fits 7b are inserted into a through-hole 6c of the motor substrate 6 to be locked with respective ones of lock concave parts 6d formed around the through-hole 6c. The snap fits 7b are provided to a plurality of positions in such a manner that each snap fit 7b is located between the pole teeth 5c of the stator core 5a (see FIG. 3B). Each snap fit 7b is a cantilever-type lock member including a holding part 7c at a projection tip-end portion in a plate-spring shape extending from the tubular part 7a in the axial direction. Specifically, as illustrated in FIG. 3A, the holding part 7c is formed in a tapered shape by a radially inner tapered part 7c1 and a radially outer tapered part 7c2. A stepped part 7c3 is projectingly provided at the radial-direction outer side in such a manner as to continue to the radially outer tapered part 7c2. The stepped part 7c3 is locked with the lock concave part 6d formed at a hole wall surface of the through-hole 6c of the motor substrate 6. Therefore, the snap fits 7b position and hold the motor substrate 6 with respect to the stator 5 in the axial direction and the radial direction.

Moreover, in FIG. 3A, the tubular part 7a includes a butting member 7d shorter than the snap fit 7b between the snap fits 7b. Therefore, during assembling of the stator 5 to the motor substrate 6, as the tubular part 7a of the insulator 7 is inserted into the through-hole 6c of the motor substrate 6, the butting member 7d contacts a substrate surface of the motor substrate 6 on an insertion-direction near side. Then, as the holding part 7c of the snap fit 7b passes through the through-hole 6c, the stepped part 7c3 is locked to a substrate surface of the motor substrate 6 on an insertion-direction farther side at the lock concave part 6d, and the motor substrate 6 is sandwiched. Therefore, the position of the motor substrate 6 with respect to the stator 5 in the axial direction is defined.

In this manner, during assembling of the motor substrate 6 to the stator 5, while the radially outer tapered part 7c2 is guided by an edge portion of the through-hole 6c of the motor substrate 6 to be deformed in the radial-direction inner side, the stepped part 7c3 is locked to the substrate opposite surface. Therefore, the motor substrate 6 can be positioned and held. Moreover, during assembling, to the housing accommodation part 4d formed upright to the bottom housing 4b, of the stator 5 to which the motor substrate 6 is assembled (stator Assy), assembling can easily be performed in such a manner that the radially inner tapered part 7c1 of the holding part 7c of the snap fit 7b flees to the radial-direction outer side so as to avoid interference with the upper-end portion 4e (butting portion on the stator core 5a) of the housing accommodation part 4d.

Moreover, in FIG. 3A, the tubular part 7a includes a pair of projection parts 7e to be fitted into respective ones of notch parts 6e provided at radially opposite positions of the through-hole 6c of the motor substrate 6 (see FIG. 4D). A length of the projection part 7e is equal to or more than a thickness of the motor substrate 6, and a width of the projection part 7e is approximately equal to a width of the notch part 6e. In this case, among the pair of projection parts 7e, clearance between the projection part 7e closer to the hall IC and the corresponding notch part 6e around the rotor shaft 3b may be less than the clearance between the projection part 7e at the opposite position and the corresponding notch part 6e.

Accordingly, during assembling of the motor substrate 6 to the stator 5, as the tubular part 7a of the insulator 7 is inserted into the through-hole 6c of the motor substrate 6, the projection parts 7e each provided between the snap fits 7b are fitted into the respective ones of the notch parts 6e provided at the radially opposite positions of the through-hole 6c. Therefore, rotation of the motor substrate 6 with respect to the stator 5 in the rotational direction can surely be detained. Accordingly, variation in assembling can be reduced, and a decrease in motor characteristics due to positional displacement of the motor substrate 6 with respect to the stator 5 as a result of motor vibration and external vibration in accordance with usage environment can be prevented.

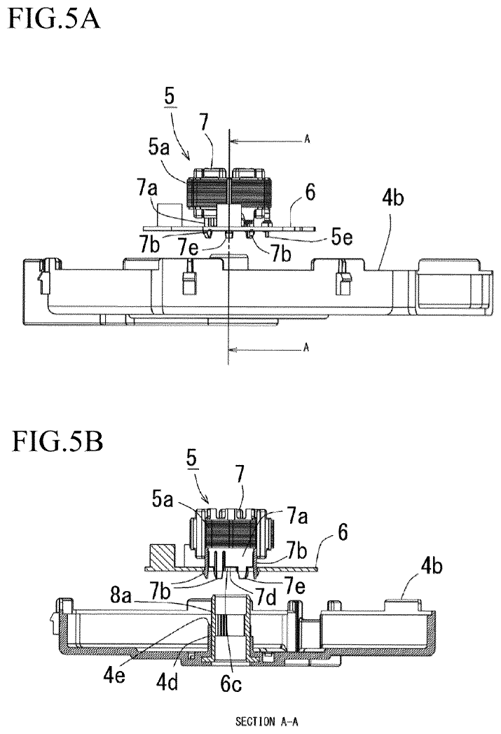

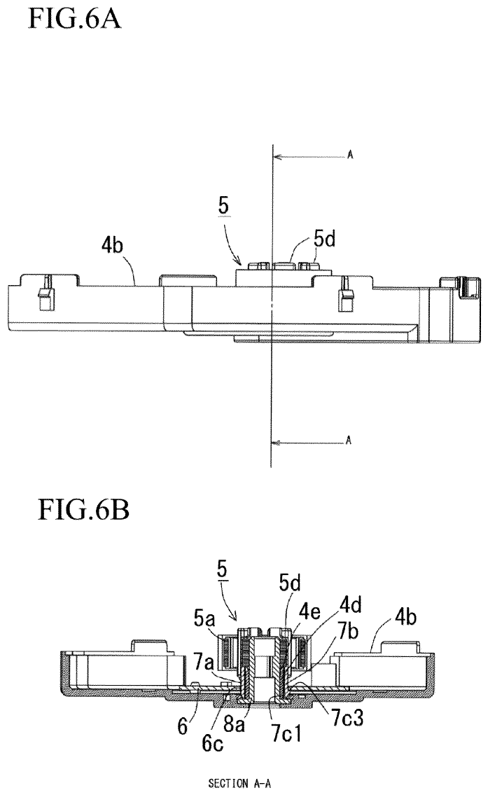

Here, one example of assembling of the outer rotor type motor M is described with reference to FIGS. 5A to 6B. The stator 5 in which the insulator 7 is insert-molded together with the stator core 5a, and the motor coil 5d is wound around the pole teeth 5c covered by the insulator 7, is prepared. At the axial-direction end portion of the tubular part 7a of the insulator 7, the snap fits 7b, the butting member 7d, and the projection parts 7e are disposed at an equal angle (see FIG. 3A).

First, as illustrated in FIGS. 5A and 5B, the motor substrate 6 is assembled to the stator 5 (see FIG. 4A). The stator 5 is inserted into the through-hole 6c of the motor substrate 6 from the tubular part 7a. At this time, insertion is performed in such a manner that the snap fits 7b are positioned with respect to the corresponding lock concave parts 6d and the projection parts 7e are positioned with respect to the corresponding notch parts 6e (see FIGS. 4B to 4D). Each snap fit 7b is inserted while the radially outer tapered part 7c2 of the holding part 7c is guided by the through-hole 6c to be deformed to radially inner side, and the snap fit 7b is locked with the lock concave part 6d of the motor substrate 6 at the stepped part 7c3 continuing to the radially outer tapered part 7c2. Note that the coil pin 5e is soldered after being inserted into the substrate terminal hole 6b.

Next, as illustrated in FIGS. 6A and 6B, the stator 5 holding the motor substrate 6 is assembled to the housing accommodation part 4d accommodating the bearing housing 8a insert-molded in the bottom housing 4b. The stator 5 is assembled in such a manner that the inner peripheral surface of the annular stator core 5a is fitted to the outer peripheral surface of the housing accommodation part 4d, at a position where the stator core 5a abuts on the upper-end portion 4e (see FIG. 6B) of the housing accommodation part 4d. At this time, the inner peripheral surface of the annular stator core 5a and the outer peripheral surface of the housing accommodation part 4d are fixed to one another by an adhesive.

Note that, during concentrical fitting of the tubular part 7a to the bearing housing 8a, the radially inner tapered part 7c1 (see FIG. 3A) of the holding part 7c of the snap fit 7b flees to the radial-direction outer side so as to avoid interference with the upper-end portion 4e of the housing accommodation part 4d accommodating the bearing housing 8a. Therefore, the stator 5 can smoothly be assembled to the bottom housing 4b.

The rotor 3 in which the rotor shaft 3b is assembled to the hub of the rotor yoke 3a, and the rotor yoke 3a and the centrifugal fan 2 are molded integrally, is prepared. Then, the rotor 3 is assembled to the stator 5. The rotor shaft 3b is inserted into the bearing housing 8a, thereby being rotatably supported by the pair of bearings 8b. The retaining washer 8c is fitted to the vicinity of the shaft end of the rotor shaft 3b to achieve retention. Accordingly, the rotor magnetic poles are arranged to face each other on the radial-direction outer side of the stator magnetic poles, and the outer rotor type motor M is assembled (see FIG. 2).

As described above, the motor substrate 6 is held in such a manner that each snap fit 7b provided to the axial-direction end portion of the tubular part 7a of the insulator 7 is inserted into the through-hole 6c of the motor substrate 6 to be locked with the lock concave part 6d formed around the through-hole 6c. Therefore, the motor substrate 6 can be positioned with respect to the stator 5 in the axial direction.

Accordingly, the outer rotor type motor M capable of surely achieving positioning of the stator 5 and the motor substrate 6 in the axial direction and the rotational direction with a simple configuration, and having favorable assemblability can be provided.

In the above-described embodiment, at the axial-direction end portion of the tubular part 7a of the insulator 7, the snap fits 7b, the butting member 7d, and the projection parts 7e are disposed at an equal angle. However, for example, in a case in which the pole teeth 5c of the stator core 5a are disposed at unequal angles, the snap fits 7b, the butting member 7d, and the projection parts 7e are not necessarily disposed at an equal angle.

Moreover, the motor substrate 6 is provided with the magnetic pole detection element 6a, such as the hall IC. However, for example, in a case of a sensorless-type DC brushless motor, the magnetic pole detection element 6a is unnecessary. In this case, the projection parts 7e provided at the opposite positions of the tubular part 7a of the insulator 7 and the notch parts 6e provided at the radially opposite positions of the through-hole 6c of the motor substrate 6 in order to detain rotation of the motor substrate 6 in the rotational direction can be omitted.

Furthermore, the insulator 7 is not necessarily molded integrally with the stator core 5a, but may be molded as a separate body and then be assembled.

What is claimed is:

1. An outer rotor type motor comprising:
a stator including stator magnetic poles created by winding of a winding wire around a plurality of pole teeth projectingly provided to a stator core with an insulator interposed between the winding wire and the plurality of pole teeth; and
a rotor including rotor magnetic poles arranged to face the stator magnetic poles on a radial-direction outer side of the stator, the rotor magnetic poles being created by permanent magnets, wherein
the stator is provided with a motor substrate including a magnetic pole detection element configured to detect a position of the rotor magnetic poles,
the insulator covering the stator core includes at a radial-direction inner side of the insulator a tubular part extending in an axial direction, the tubular part including, at a plurality of positions in a circumferential direction of the tubular part, snap fits inserted into a through-hole of the motor substrate to be locked with respective ones of lock concave parts to position and hold the motor substrate with respect to the stator in the axial direction and a radial direction, the lock concave parts being formed at a hole wall surface of the through-hole, and
the stator is concentrically assembled on an outer peripheral side of a housing accommodation part accommodating a bearing housing while the snap fits position and hold the motor substrate.

2. The outer rotor type motor according to claim 1, wherein each of the snap fits includes a holding part provided to a tip-end portion of the snap fit, the holding part being formed in a tapered shape by a radially inner tapered part and a radially outer tapered part, and
the holding part is locked with the motor substrate at a stepped part projectingly provided at the radial-direction outer side in such a manner as to continue to the radially outer tapered part.

3. The outer rotor type motor according to claim 1, wherein each of the snap fits is projectingly provided between the stator pole teeth in the circumferential direction of the tubular part.

4. The outer rotor type motor according to claim 1, wherein the tubular part includes a butting member between the snap fits, the butting member defining a position of the motor substrate in the axial direction in such a manner as to abut on a surface of the motor substrate in the axial direction and catch the motor substrate together with the snap fits.

5. The outer rotor type motor according to claim 1, wherein the tubular part includes a projection part between the snap fits, the projection part being fitted, for positioning in a rotational direction, into a notch part provided at a respective one of radially opposite positions of the through-hole of the motor substrate.

6. The outer rotor type motor according to claim 1, wherein the insulator is insert-molded with the stator core and includes the tubular part, and the tubular part includes a projection tip-end portion in a plate-spring shape at which a holding part is formed.
